(19) United States
(12) Patent Application Publication
(10) Pub. No.: US 2011/0031195 A1
(43) Pub. Date: Feb. 10, 2011

(54) System and Method for Recirculating/Filtering/Flushing a Water Main

(76) Inventor: Chris E. Wilkinson, Los Lunas, NM (US)

Correspondence Address: Woods Oviatt Gilman LLP, 700 Crossroads Bldg, 2 State St., Rochester, NY, 14614, US

(21) Appl. No.: 12/537,537

(22) Filed: Aug. 7, 2009

(51) Int. Cl. C02F 9/08

(52) U.S. Cl. 210/790; 210/195.4; 210/87; 210/117; 210/803; 210/801

(57) ABSTRACT

A recirculating/filtering/flushing system for cleaning a water main is provided, wherein the water main includes first and second access points. The system comprises at least one filter for filtering water in the water main; an inlet conduit coupled with the first access point and the at least one filter; an outlet conduit coupled with the second access point and the at least one filter; a bypass conduit coupled with the inlet conduit at a first location upstream of the at least one filter, and coupled with the outlet conduit at a second location downstream of the at least one filter; and a pumping device for flowing the water in the water main through the inlet conduit, through either the at least one filter or the bypass conduit, and through the outlet conduit.

### TECHNICAL FIELD

The present invention relates to a system and method for cleaning a water conduit, such as a water main, that is susceptible to accumulation of deposits, sediment, and particulates; more particularly, to a system and method for flushing successive portions of a water main via a closed recirculation system; and most particularly, to a system and method for flushing successive portions of a water main via a closed recirculation system at a higher flow rate and larger water main diameter than is possible with existing systems.

### BACKGROUND OF THE INVENTION

Almost all water providers are required to have their distribution mains large enough to provide a sufficient flow for fire protection. This means that the flow rate or velocities in the large mains during normal use are reduced significantly, allowing any particulates to settle to the bottom of the water main. After a length of time, the particulates can build up in the water main, and if there are any surges in the system, the particulates are stirred up and suspended in the water causing the water to appear dirty. To remedy this occurrence, the entire system typically is flushed annually from hydrants and blow-offs throughout the entire system. This method wastes millions of gallons of water each year; can cause property damage; can flood streets causing traffic problems; and typically is performed at night to avoid the public eye, making the flushing procedure very costly. In addition, because municipal water typically is treated with chlorine, for environmental reasons, steps must be taken at the flushing outlets to neutralize the chlorine.

U.S. Pat. No. 6,627,089, issued Sep. 30, 2003 to Wilkinson, which is hereby incorporated by reference, discloses a system and method for avoiding the mass discharge of water and treatment thereof by recirculating the water through a filtration truck and pump connected in a closed loop between adjacent hydrants on a water main. The pump recirculates the water through the filters at a flow rate sufficiently high enough to dislodge and transport accumulated sediments and other debris in that portion of the main between the hydrants. By proceeding from one hydrant to the next, the entire main may be cleaned without the discharge of any significant volume of water.

An issue arises in application of prior art methods and apparatus in accordance with the incorporated reference in that recirculation flow rates are limited by the filtration flow capacity of the apparatus. Referring to Table I, as set forth below, it is seen that, for example, a flow velocity of 5 ft/sec (the normally desired flushing flow rate) through an 8-inch main (a common size for small to medium water systems) requires a volumetric flow rate of 783 gallons/minute (gpm):

TABLE I
Main Diameters

| | For 3 ft/sec Velocity | | For 5 ft/sec Velocity |
|---|---|---|---|
| 2″ | 29 gpm | 2″ | 49 gpm |
| 4″ | 117 gpm | 4″ | 196 gpm |
| 6″ | 264 gpm | 6″ | 441 gpm |
| 8″ | 470 gpm | 8″ | 783 gpm |
| 10″ | 734 gpm | 10″ | 1224 gpm |
| 12″ | 1057 gpm | 12″ | 1762 gpm |
| 14″ | 1439 gpm | 14″ | 2399 gpm |
| 16″ | 1880 gpm | | |

Because the maximum flow capacity of the pump cannot push the water at a high enough flow rate to scour a large diameter water main and at the same time overcome the force required to push the water through the filters, a recirculation/filtration system sized to flush an 8-inch water main cannot successfully flush water mains of greater diameter. This imposes a serious limitation on the ability of a system operator to expand operations into larger diameter water mains.

What is needed in the art is a system and method for a expanding the water main diameter range of a water main recirculating/filtering/flushing system otherwise limited in accordance with the prior art.

It is one aspect of the present invention to provide a system and method for cleaning water mains larger in diameter than can be accommodated in accordance with prior art systems.

### SUMMARY OF THE INVENTION

Briefly described, a water main cleaning system in accordance with the present invention comprises at least one filter and a pump connectable in a closed loop between adjacent hydrants on a water main. The present invention provides valving and piping to permit selective by-passing of the filters to provide high water velocity through the water main that necessary to dislodge accumulated sediment, while also allowing for lower water velocity in order to filter the resulting turbid water. In a method of operation, the at least one filter is bypassed for an initial scouring period, allowing high velocity water to be passed through the portion of the water main being flushed, causing sediment to be driven temporarily into suspension. The system then diverts the water flow through the at least one filter at a lower flow rate commensurate with the flow limit of the at least one filter so that the suspended sediment is filtered out of the water. The cycle of operation may be repeated as necessary until the water quality is acceptable. Thus, the invention permits cleaning of larger water mains than can be accommodated using the prior art apparatus and method alone using a similarly sized pump.

In particular, the present invention is directed to a recirculating/filtering/flushing system for cleaning a water main, wherein the water main includes first and second access points. The system comprises at least one filter for filtering water in the water main; an inlet conduit coupled with the first access point and the at least one filter; an outlet conduit coupled with the second access point and the at least one filter; a bypass conduit coupled with the inlet conduit at a first location upstream of the at least one filter, and coupled with the outlet conduit at a second location downstream of the at least one filter; and a pumping device for flowing the water in the water main through the inlet conduit, through either the at least one filter or the bypass conduit, and through the outlet conduit.

The present invention is also directed to a method for cleaning a water main having first and second access points. The method comprises the steps of: a) connecting a pumping device and at least one filter between the first and second access points of the water main; b) pumping the water through the water main in a first direction of flow between the first and second access points at a first flow velocity sufficient to release sediments in the water main, while bypassing the at least one filter; and c) pumping the water through the water main and through the at least one filter between the first and second access points at a second flow velocity to remove the sediments from the water, wherein the first flow velocity is greater than the second flow velocity.

In addition, the present invention is also directed to a method for operating a recirculating/filtering/flushing system for cleaning a water main including first and second access points. The system includes at least one filter for filtering the water in the water main, an inlet conduit coupled with the at least one filter, an outlet conduit coupled with the at least one filter, a bypass conduit coupled with the inlet conduit at a first location upstream of the at least one filter and coupled with the outlet conduit at a second location downstream of the at least one filter, a pumping device for flowing the water in the water main through the system, a first valve disposed in the inlet conduit between the first location and the at least one filter, a second valve disposed in the bypass conduit, and a third valve disposed in the outlet conduit between the second location and the at least one filter. The method comprises: a) connecting the inlet conduit to the first access point of the water main; b) connecting the outlet conduit to the second access point of the water main; c) closing the first and third valves and opening the second valve; d) energizing the pumping device to cause water to flow in a first direction at a first flow velocity through the inlet conduit, the bypass conduit, the outlet conduit, and the portion of the water main between the first and second access points; e) opening the first and third valves and closing the second valve to cause the water to flow through the at least one filter at a second flow velocity, wherein the second flow velocity is less than the first flow velocity; f) de-energizing the pumping device; and g) disconnecting the inlet conduit from the first access point and disconnecting the outlet conduit from the second access point.

Furthermore, the present invention is directed to a method for cleaning a water main having first and second access points, wherein water in the water main flows in a first direction of distribution flow. The method comprises the steps of: a) connecting a pumping device and at least one filter between the first and second access points of the water main; and b) pumping the water through the water main in a second direction of flow between the first and second access points and through the at least one filter at a first flow velocity, wherein the second direction of flow is opposite to the first direction of distribution flow in the water main.

### BRIEF DESCRIPTION OF THE DRAWINGS

The present invention will now be described, by way of example, with reference to the accompanying drawings, in which:

FIG. 1 is a schematic drawing of a prior art water main cleaning system substantially as disclosed in U.S. Pat. No. 6,627,089;

FIG. 2 is a schematic drawing showing a first embodiment of a water main cleaning system in accordance with the present invention;

FIG. 3 is a plan view of a second embodiment of a water main cleaning system in accordance with the present invention; and

FIG. 4 is an elevational view of the system shown in FIG. 3.

Corresponding reference characters indicate corresponding parts throughout the several views. The exemplifications set out herein illustrate currently preferred embodiments of the present invention, and such exemplifications are not to be construed as limiting the scope of the invention in any manner.

### DETAILED DESCRIPTION OF THE INVENTION

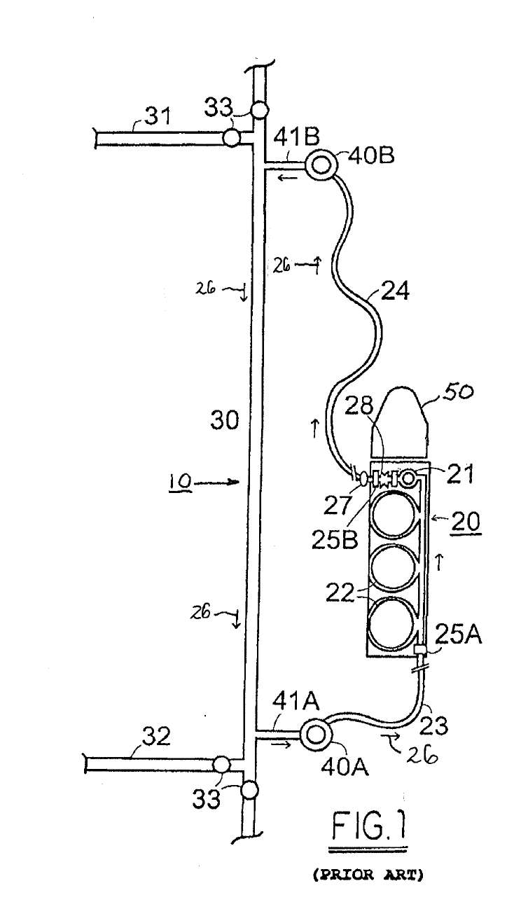

Referring to FIG. 1, a prior art portable recirculating/filtering/flushing system 20 for cleaning a water supply system 10 comprises at least one pumping device 21, at least one filter 22, and inlet and outlet conduits 23, 24, such as hoses, forming a closed conduit and filtering system capable of being portably mounted on a truck, trailer, or other vehicle.

The closed conduit and filtering system 20 conducts a flow of water (flow direction indicated by arrows 26) between a first point and a second point in water supply system 10 which comprises a water main 30, service mains 31, 32, valves 33, and trunk pipes 41A, 41B connected to first and second access points 40A, 40B, respectively, such as adjacent hydrants on water main 30. The recirculating/filtering/flushing system 20 conducts the flow of water out of water main 30 at the first point via trunk pipe 41A to hydrant 40A, through first hose 23, and returns the flow of water, after filtering, through second hose 24 back into water main 30 at the second point via trunk pipe 41B from hydrant 40B. Preferably, second hose 24 is provided with a spring-loaded flapper valve 27 to keep the system from draining after disconnecting the second hose 24 from the hydrant 40B.

At least one pumping device 21 pumps water out of water main 30 from hydrant 40A through filters 22 and back into water main 30 through hydrant 40B. Pumping device 21 causes an increased flow rate of the water flowing within water supply system 10 through water main 30 from the second access point, hydrant 40B, to the first access point, hydrant 40A. The increased flow rate through water main 30, which is turbulent flow, stirs up any undesirable matter, including deposits, sediment, and particulates in water supply system 10 between hydrants 40B and 40A, forming a temporary turbid suspension. System 20 may further include a metering system 28 for measuring the flow rate of the water passing through the system 20.

At least one filter, and preferably a plurality of filters 22, receives the flow of water through recirculating/filtering/flushing system 20 and filters out all of the undesirable matter from the turbid suspension outside of water supply system 10 so that water supply system 10 is cleaned of all undesirable matter in water main 30 between hydrants 40B and 40A. All of the flow of water taken from water supply system 10 is returned to water supply system 10. No water is wasted or run off into the environment.

The quality of the flow of water in closed conduit system 20 may be inspected, optionally, by allowing for the viewing and visual inspection of the flow of water. For example, a first check valve and first section of clear tube 25A may be provided for inspecting the flow of water coming into the closed conduit system 20, and a second check valve and second section of clear tube 25B may be provided for inspecting the flow of water leaving filters 22.

Closed conduit system 20 with hoses 23, 24, plurality of filters 22, pump 21, and inspecting stations 25A, 25B, are all preferably mounted on a portable means of transport 50, such as a large bobtail truck, semi truck/trailer, a trailer, or other mobile means for moving system 20 to all points in the water supply system for sequentially cleaning one section of main 30 at a time.

In practice, a prior art method of re-circulating/filtering/flushing for cleaning water supply systems comprises the step of pumping water from main 30 through closed conduit system 20, including the step of filtering all of the water flow during all of such pumping, retaining the flow of water within the closed conduit system and not letting any of the water escape into the environment.

The step of pumping the flow of water by at least one pump 21 from the first access point, hydrant 40A, in the water supply through the closed conduit system 20 to the second access point, hydrant 40B, in the water supply system creates an increased flow rate of the water flowing within the water supply system 10 through the water main 30 from the second access point, hydrant 40B, to the first access point, hydrant 40A.

The increased flow rate, preferably 5 ft/sec, cleans any undesirable matter, such as deposits, sediment, particulates, and other contaminants in the water supply system between the second access point, hydrant 40B, and the first access point, hydrant 40A.

As noted above, the flow velocity through water main 30 during use of prior art system 20 is limited by the ability of the pumping device 21 to push the water through filters 22. As seen in Table I set forth above, larger diameter mains require higher water flow rates through system 20 to maintain the required flow velocity in a water main of 5 ft/sec. However, only by increasing the size of pumping device 21 or reducing the amount of force needed to push the water through filters 22 can the flow velocity of system 20 be increased.

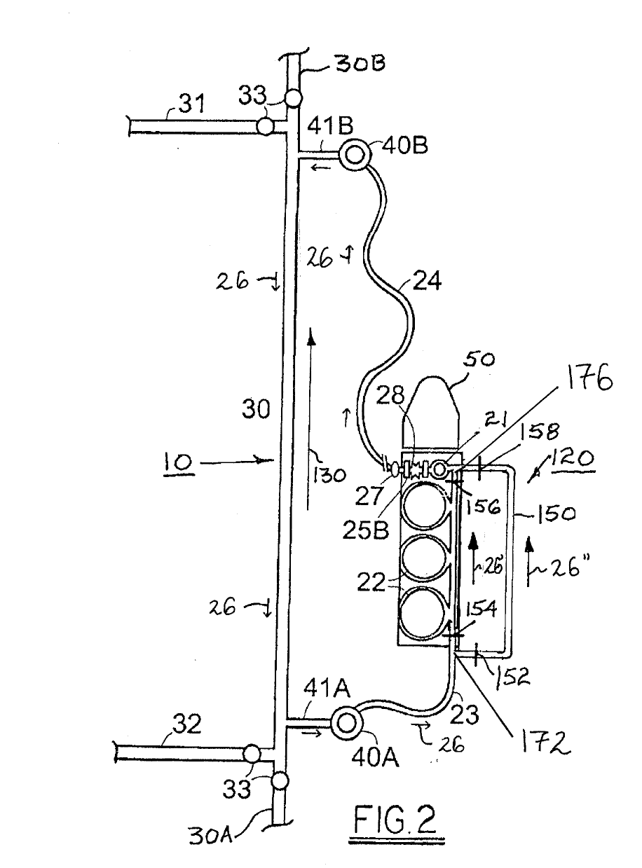

Referring to FIG. 2, an improved recirculating/filtering/flushing system 120 in accordance with the present invention overcomes the prior art limitation by addressing the dual requirements of providing sufficient flow velocity through the water main to adequately scour large diameter water mains and adequately filter suspended particles using the filters without having to increase the size of the pumping device or reduce the amount of force needed to push the water through the filters.

Improved recirculating/filtering/flushing system 120 may include the conduits (hoses), pumping device, filters, valves, and the like of system 20 shown in FIG. 1, and therefore need not be repeated. To achieve the required flow velocity through water main 30, system 120 includes a bypass conduit 150 and valves 152, 154, 156, 158 arranged such that water flow through system 120 may be pumped either through 26′ or around 26″ to bypass the filters 22. Bypass conduit 150 is coupled with the inlet conduit 23 at a first location 172 upstream of the filters 22, and is coupled with the outlet conduit 24 at a second location 176 downstream of the filters 22. The valve 152 is disposed in the inlet conduit 23 between first location 176 and the filters 22. The valves 154, 156 are disposed in the bypass conduit 150. The valve 158 is disposed in the outlet conduit 24 between the second location 176 and the filters 22.

In operation, at the start of a flushing operation, improved system 120 is connected to water supply system 10 exactly as in the prior art use of system 20.

Preferably system 120, having flow in the direction shown by arrows 21, is connected to water supply system 10 such that flushing flow through water main 30 is counter to the general direction 130 of water being supplied through water supply system 10 (i.e., reverse flow method). When prior art conventional open-system or uni-directional flushing is conducted, stirred up sediment and particulate matter almost always become present in upstream and downstream areas of the distribution system, because an entire distribution system cannot be flushed all at once.

All water systems have a source entry point at the water treatment plant; wells and/or suppliers access points may also be tied into the distribution system. Users of the water, such as service mains 31, 32, are normally located just downstream of the source tie-in points, and continue out to the ends of the distribution system. This means that the water always flows from the source on out towards the ends of the water distribution system, defining general flow direction 130.

As an example, if the general distribution flow is 30 gpm traveling in direction 130 through a 6″ main to be flushed, system 120 will circulate the water to its desired Table I flow rate of 441 gpm (plus 30 gpm) in the opposite direction 21. The normal 30 gpm distribution system flow will be forced to travel through the temporarily connected system 120 and then continue on down water main 30 on its normal direction of flow 130, only now having been filtered. The velocity inside the upstream and downstream sections 30A, 30B, respectively, of main 30 are unaffected by the induced circulated flows. As such, it may be unnecessary to isolate a section of the water supply system 10 by closing valves 33 when using the reverse flow method with the improved system 120 to clean a section of the water main 30. However, it should be understood that the improved system 120 may also be used without the reverse flow method described above.

After system 120 is connected to water main 30 by connecting hose 23 with hydrant 40A and connecting hose 24 with hydrant 40B, system 120 is filled with water by opening hydrants 40A, 40B by energizing pumping device 21. Pumping device 21 and filters 22 are therefore connected between the hydrants 40A, 40B. Valves 154, 156 are then closed, and valves 152, 158 are opened. Pumping device 21 is energized to drive water through system 120, via bypass line 150, and water main 30 in direction 26, 26″ at a first flow rate that is required to produce a velocity of at least 5 ft/sec, for example, through that portion of water main 30 between hydrants 40A, 40B. At the first flow rate, sediment and other particulate matter is scoured from water main 30 and stirred into the water, producing a recirculating temporary turbid suspension. In general, the first flow rate may correspond to a flow rate that exceeds a maximum flow rate capability of the filters 22. A the water is flowing through bypass line 150, the water is not flowing through filters 22.

After an appropriate period of flow at the first flow rate, valves 154, 156 are opened and valves 152, 158 are closed to direct the flow 26, 26′ of turbid suspension through filters 22 where the sediment and other particulate matter are removed. The water being fed through filters 22 is at a second flow rate, which is less than the first flow rate that was used to scour water main 30, at least in part due to the resistance of flow caused by the water passing through the media in filters 22. After passing through filters 22, the cleaned and disinfected water is then discharged back into water main 30 in the general direction of distribution flow 130. Because of mixing filtered water with turbid water in main 30, the captive water volume may need to be recirculated through system 120 for a number of cycles, wherein the number of cycles being generally dependant upon the amount of particulates to be removed.

When the recirculating water is satisfactorily cleaned by system 120, pumping device 21 is de-energized, hydrants 40A, 40B are closed, and system 120 is disconnected from the hydrants, completing the operation of cleaning a portion of water main 30 between hydrants 40A, 40B.

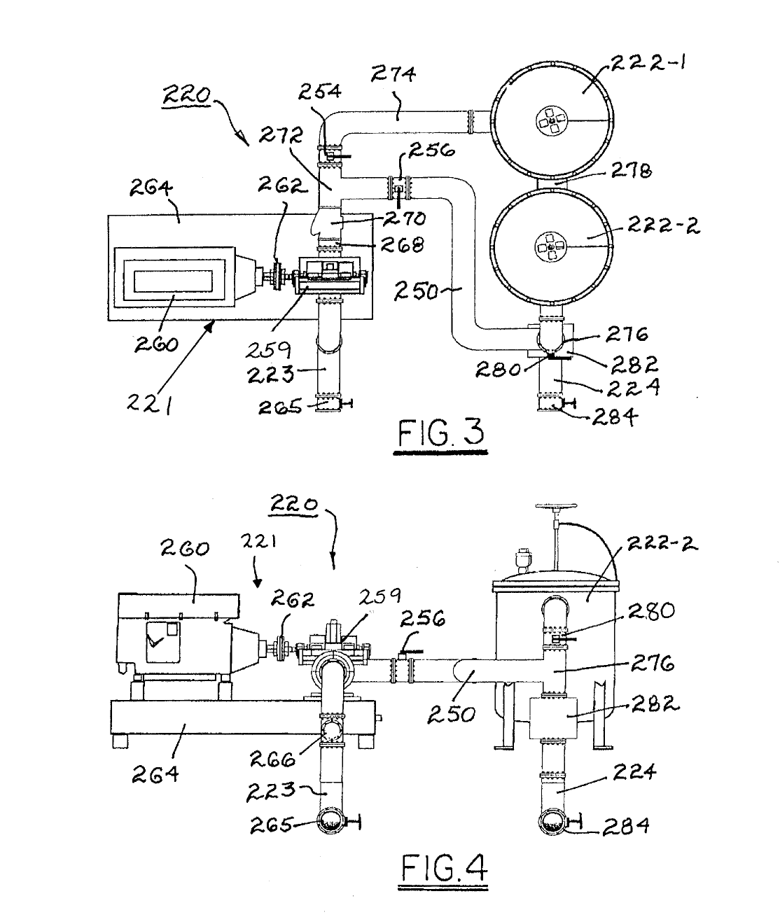

Referring to FIGS. 3 and 4, a currently preferred embodiment 220 of an improved recirculating/filtering/flushing system in accordance with the present invention is shown. Pumping device 221 includes a pump 259 and a pump drive 260 connected to pump 259 via a coupling 262, are mounted on a portable pallet 264 or alternatively may be mounted directly on the bed (not shown) of a trailer, truck, or the like. Pump drive 260 may include an electric motor, hydraulic motor, or an internal combustion engine. Intake conduit 223, for example a hose, is coupled with an inlet shutoff valve 265 and is connected to pump 259 preferably via an inline coarse sand strainer 266. A pump outlet hose 268 preferably includes an inline check valve 270. Flow from outlet hose 268 is split at a first location 272, a filter feed hose 274 is connected to a roughing filter 222-1 via a first filter valve 254, and a filter bypass hose 250 is connected to a second location 276 via a single bypass valve 256. A connector 278 couples roughing filter 222-1 in series with a polishing filter 222-2 which is connected to second location 276 via a second filter valve 280. An optional disinfection unit 282 including at least one of an ultraviolet disinfector and a biofilm removal device may be connected to second location 276 and to an outlet conduit 224, such as a hose, terminating at an outlet shutoff valve 284 downstream of filters 222-1, 222-2.

The biofilm removal device may take the form of a one micro absolute filter element to capture the scoured and suspended biofilm during the flushing process. The ultraviolent disinfector will enable system 220 to be used in water distribution systems that do not require and/or desire additional disinfectant chemicals to be added, and adds an additional level of protection, particularly in relation to Guardia, Cryptosporidium and other chlorine and chloramine resistant microbes.

Operation of system 220 is the same as for system 120 as described above, except that, additionally, inlet and outlet shutoff valves 265, 284 are opened after connection to hydrants 40A, 40B before starting pumping device 221 and closed before disconnecting system 220 from hydrants 40A, 40B. In addition, instead of including two valves in the bypass conduit 150 in system 120, system 220 includes one bypass valve 256 therein.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A recirculating/filtering/flushing system for cleaning a water main, the water main including first and second access points, the system comprising:
at least one filter for filtering water in the water main;
an inlet conduit coupled with the first access point and the at least one filter;
an outlet conduit coupled with the second access point and the at least one filter;
a bypass conduit coupled with the inlet conduit at a first location upstream of the at least one filter, and coupled with the outlet conduit at a second location downstream of the at least one filter; and
a pumping device for flowing the water in the water main through the inlet conduit, through either the at least one filter or the bypass conduit, and through the outlet conduit.

2. A system in accordance with claim 1 further comprising:
a first valve disposed in the inlet conduit between the first location and the at least one filter;
a second valve disposed in the bypass conduit; and
a third valve disposed in the outlet conduit between the second location and the at least one filter.

3. A system in accordance with claim 1 further comprising:
an inlet valve disposed in the inlet conduit between the first location and the at least one filter; and
an outlet valve disposed in the outlet conduit between the second location and the at least one filter.

4. A system in accordance with claim 1 further comprising a disinfection unit disposed downstream of the at least one filter.

5. A system in accordance with claim 1 wherein the at least one filter comprises at least one roughing filter and one polishing filter connected in series.

6. A system in accordance with claim 1 wherein the pumping device includes a pump and a pump drive.

7. A system in accordance with claim 7 wherein the pump drive is selected from the group consisting of an electric motor, an internal combustion engine, and a hydraulic motor.

8. A system in accordance with claim 1 further comprising a pallet for supporting the pumping device and the at least one filter.

9. A system in accordance with claim 1 wherein the outlet conduit includes a check valve and a transparent section to visually inspect the flow of water flowing therethrough.

10. A system in accordance with claim 1 wherein the inlet conduit and the outlet conduit are both hoses.

11. A system in accordance with claim 1 wherein the outlet conduit includes a spring-loaded flapper valve to keep the system from draining after disconnecting the outlet conduit from the second access point of the water main.

12. A method for cleaning a water main having first and second access points, the method comprising the steps of:
a) connecting a pumping device and at least one filter between the first and second access points of the water main;
b) pumping the water through the water main in a first direction of flow between the first and second access points at a first flow velocity sufficient to release sediments in the water main, while bypassing the at least one filter; and
c) pumping the water through the water main and through the at least one filter between the first and second access points at a second flow velocity to remove the sediments from the water, wherein the first flow velocity is greater than the second flow velocity.

13. A method in accordance with claim 12 wherein the first and second access points are adjacent hydrants on the water main.

14. A method in accordance with claim 12 wherein the first flow velocity corresponds to a water flow rate that exceed a maximum flow rate capability of the at least one filter.

15. A method in accordance with claim 12 wherein the first direction of flow is opposite to a general direction of flow of water in the water main.

16. A method for operating a recirculating/filtering/flushing system for cleaning a water main including first and second access points, the system including at least one filter for filtering the water in the water main, an inlet conduit coupled with the at least one filter, an outlet conduit coupled with the at least one filter, a bypass conduit coupled with the inlet conduit at a first location upstream of the at least one filter and coupled with the outlet conduit at a second location downstream of the at least one filter, a pumping device for flowing the water in the water main through the system, a first valve disposed in the inlet conduit between the first location and the at least one filter, a second valve disposed in the bypass conduit, and a third valve disposed in the outlet conduit between the second location and the at least one filter, the method comprising:
a) connecting the inlet conduit to the first access point of the water main;
b) connecting the outlet conduit to the second access point of the water main;
c) closing the first and third valves and opening the second valve;
d) energizing the pumping device to cause water to flow in a first direction at a first flow velocity through the inlet conduit, the bypass conduit, the outlet conduit, and the portion of the water main between the first and second access points;
e) opening the first and third valves and closing the second valve to cause the water to flow through the at least one filter at a second flow velocity, wherein the second flow velocity is less than the first flow velocity;
f) de-energizing the pumping device; and
g) disconnecting the inlet conduit from the first access point and disconnecting the outlet conduit from the second access point.

17. A method for cleaning a water main having first and second access points, wherein water in the water main flows in a first direction of distribution flow, the method comprising the steps of:
a) connecting a pumping device and at least one filter between the first and second access points of the water main; and
b) pumping the water through the water main in a second direction of flow between the first and second access points and through the at least one filter at a first flow velocity, wherein the second direction of flow is opposite to the first direction of distribution flow in the water main.

18. A method in accordance with claim 17, wherein, prior to pumping the water through the at least one filter at a first flow velocity, the water is pumped through the water main in the second direction of flow between the first and second access points at a second flow velocity sufficient to release sediments in the water main, while bypassing the at least one filter, wherein the second flow velocity is greater than the first flow velocity.
